(19) United States
(12) Patent Application Publication
(10) Pub. No.: US 2021/0146214 A1
(43) Pub. Date: May 20, 2021

(54) FENCING MASK EQUIPPED WITH SCORE LIGHT INDICATOR DEVICE

(71) Applicant: ChaeHyun LIM, Seoul (KR)

(72) Inventor: ChaeHyun LIM, Seoul (KR)

(21) Appl. No.: 16/818,471

(22) Filed: Mar. 13, 2020

(30) Foreign Application Priority Data
Nov. 18, 2019 (KR) 10-2019-0147269

(51) Int. Cl. A63B 69/02; A63B 71/10

(52) U.S. Cl. CPC A63B 69/02; A63B 2071/105; A63B 71/10

(57) ABSTRACT

Disclosed herein is a fencing mask equipped with a score light indicator device. The fencing mask includes: a fencing mask body configured to protect the head of a fencer in a fencing competition; a forehead protector configured to be provided inside the fencing mask body and to protect the forehead of the fencer; and a lighting module configured to be located between the inside of the mask body and the forehead protector. The lighting module includes a plurality of light sources, and the light sources constituting the lighting module selectively emit light in response to electric signals generated by a fencing weapon that is used in fencing.

### CROSS-REFERENCE TO RELATED APPLICATION

This application claims the benefit of Korean Patent Application No. 10-2019-0147269 filed on Nov. 18, 2019, which is hereby incorporated by reference herein in its entirety.

### BACKGROUND

### 1. Technical Field

The present invention relates to a fencing mask equipped with a score light indicator device, and more specifically to a fencing mask equipped with a score light indicator device, in which a lighting device capable of indicating a gain of a score, a loss of a score, and the invalidity of a score is provided inside a fencing mask, thereby allowing for competition situations to be immediately perceived.

### 2. Description of the Related Art

Fencing is classified into three disciplines: foil fencing, epee fencing, and saber fencing, which are performed using different weapons and rules.

In foil fencing, only a thrust using the tip of a weapon is valid as in epee fencing. Foil fencing requires fast attacking motions. Foil fencing is a classical fencing discipline in which a winner is determined according to the rules of the attack and defend theory that recognizes the right to attack and the right to defend. In foil fencing, a winner is determined by attacking the upper body except for the arms and head.

In epee fencing, fencers use a rigid weapon with a guard larger than that of foil fencing, and may make full-body attacks. Epee fencing does not depend on detailed rules unlike the other disciplines in fencing. In epee fencing, a gain or loss of a score is determined depending on the duration of thrusting time. Accordingly, a winner is determined by thrusting before his or her opponent.

In saber fencing, fencers make attacks by cutting or thrusting the upper body of their opponent including the arms and head of the opponent, and use a flexible weapon with a guard capable of covering their hand.

In all these disciplines in fencing, electrical connectors are designed to detect the allocation of scores by means of optical (and acoustic) members disposed in a competition area, and transmit signals to an electrical judging apparatus. The electrical judging apparatus is equipped with a signal transmission system configured to transmit signals.

In general, a fencing court in which a competition is held is equipped with white, green and red lights that are activated whenever a score is allocated. Accordingly, the electrical judging apparatus transmits signals to a scoreboard through cables connected to the jackets of fencers that are extended to end areas of the fencing court.

Gains of scores, losses of scores, and the invalidity of scores as well as scores are immediately incorporated into and displayed on the scoreboard through the cables connected to the fencers. The fencers must keep an eye on the scoreboard because they need to establish their strategy while checking the scoreboard during a competition.

However, a problem arises in that it is difficult to move the face or body in order to see the scoreboard in a considerably fast fencing competition. Although a buzzer may sound during the competition, the fencers may not hear it because fencing masks cover the ears of the fencers and also it is heard along with cheering sounds.

Furthermore, in some international fencing competitions, scoreboards are disposed among fencers, or are placed behind fencers. These scoreboards are installed and operated for referees and spectators rather than for fencers, and thus a problem arises in that the scoreboards are not helpful directly to fencers.

### SUMMARY

The present invention has been conceived to overcome the above-described problems of the prior art, and an object of at least one embodiment of the present invention is to provide a fencing mask equipped with a score light indicator device, which is capable of indicating a gain of a score, a loss of a score, and the invalidity of a score.

According to an aspect of the present invention, there is provided a fencing mask equipped with a score light indicator device, the fencing mask including: a fencing mask body configured to protect the head of a fencer in a fencing competition; a forehead protector configured to be provided inside the fencing mask body and to protect the forehead of the fencer; and a lighting module configured to be located between the inside of the mask body and the forehead protector; wherein the lighting module includes a plurality of light sources, and the light sources constituting the lighting module selectively emit light in response to electric signals generated by a fencing weapon that is used in fencing.

The lighting module may include a green light source, a red light source, and a white light source.

The green light source, the red light source, and the white light source may be spaced apart from one another.

The green light source, the red light source, and the white light source may emit light individually or in combination.

The lighting module may be controlled by an electrical judging apparatus configured to receive electric signals generated by the fencing weapon and to determine a result of the fencing competition.

The fencing mask may further include a communication module configured to receive signals from the electrical judging apparatus and a control unit configured to process the signals received by the communication module.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a schematic diagram showing a state in which a fencing competition is held in a fencing stadium;

FIG. 2 is a schematic front view showing a fencing mask equipped with a score light indicator device according to one embodiment of the present invention; and

FIG. 3 is a schematic rear view showing the fencing mask equipped with a score light indicator device according to the one embodiment of the present invention.

### DETAILED DESCRIPTION

The embodiments described below are provided to enable those skilled in the art to easily understand the technical spirit of the present invention, and the present invention is not limited thereto. Furthermore, the items represented in the accompanying drawings are schematically shown in order to easily illustrate the embodiments of the present invention, and may be different from those actually implemented in practice.

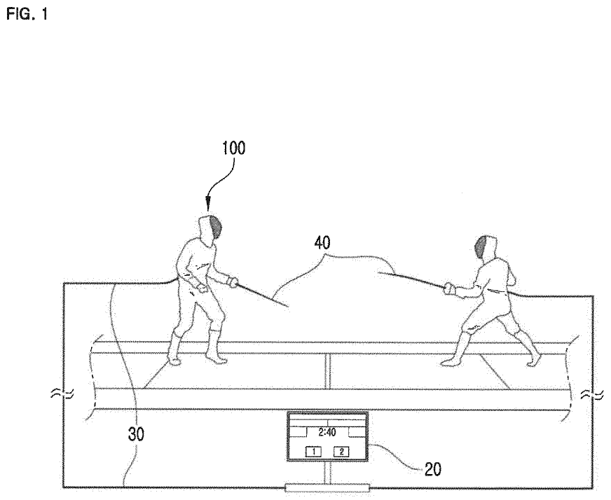

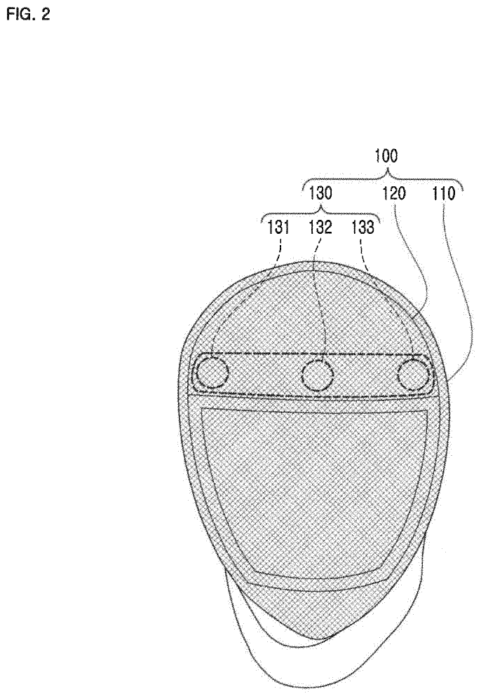

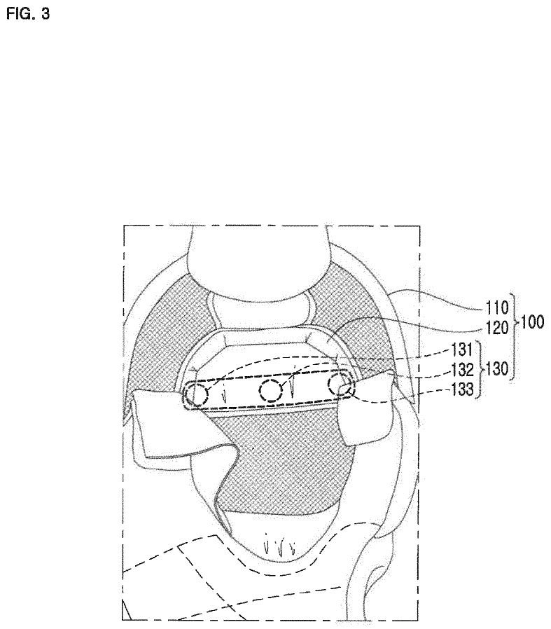

FIG. 1 is a schematic diagram showing a state in which a fencing competition is held in a fencing stadium, FIG. 2 is a schematic front view showing a fencing mask equipped with a score light indicator device according to one embodiment of the present invention, and FIG. 3 is a schematic rear view showing the fencing mask equipped with a score light indicator device according to the one embodiment of the present invention.

Referring to FIGS. 1 to 3 together, the fencing mask 100 equipped with a score light indicator device according to the one embodiment of the present invention includes a fencing mask body 110 configured to protect the head of a fencer in a fencing competition, a forehead protector 120 configured to be provided inside the fencing mask body 110 and to protect the forehead of the fencer, and a lighting module 130 configured to be located between the inside of the mask body 110 and the forehead protector 120. The lighting module 130 includes a plurality of light sources, and the light sources constituting the lighting module 130 selectively emit light in response to electric signals generated by a fencing weapon 40 that is used in fencing. The electric signals generated by fencing weapons 40 are transmitted to an electrical judging apparatus through cables 30, and results are shown on a scoreboard 20 connected to the electrical judging apparatus. In this case, the cables are also called reels, and function to connect the electrical judging apparatus and fencer equipment. The electrical judging apparatus and the scoreboard may be integrated with each other.

According to the present invention, the front part of the fencing mask body 110 is made of a metal mesh and protects the head of the fencer, and the forehead protector 120 configured to protect the forehead of the fencer is provided inside the fencing mask body 110.

In one specific example, the lighting module 130 includes a green light source 131, a red light source 133 and a white light source 132, and the green light source 131, the red light source 133 and the white light source 132 are spaced apart from one another.

In the lighting module 130, the white light source 132 is located at the center thereof, and the green light source 131 and the red light source 133 are located on the left and right sides thereof. Furthermore, the lighting module 130 is located above the lower end of the forehead protector 120 on a horizontal basis.

In this case, the green light source 131, the red light source 133 and the white light source 132 may emit light individually or in combination according to a competition result.

The lighting module 130 receives an electric signal generated by the fencing weapon 40 in a fencing court, and emits light along with the scoreboard 20 configured to determine the result of a fencing competition. The scoreboard 20 may be controlled by the electrical judging apparatus, and the lighting module 130 may be controlled by the electrical judging apparatus.

In this case, the fencing court is also called a piste. In both epee and saber fencing, the pistes thereof are 14 m long, are 1.8 to 2 m wide and allow for fencers to use a length of 5 m as long as they do not cross the rear limit lines, with an extension of substantially 1.5 to 2 m at either end in order to allow retreat. In foil fencing, the pistes thereof have the same width as those of epee and saber fencing, are 12 m long, and allow for fencers to freely move throughout 4 m as long as they do not cross the limit lines.

In pistes common to all the disciplines, when the back foot of a fencer reaches a warning line, a referee stops a competition and warns that the back foot reaches the warning line. A fencer who has crossed a limit line with his or her both feet after the warning is considered to have been hit. A fencer who has moved to a side of a piste loses a ground of 1 m in the case of foil fencing, and loses a ground of 2 m in the case of epee and saber fencing.

Meanwhile, in addition to the above-described configuration, the fencing mask 100 equipped with a score light indicator device according to the present invention may further include a communication module configured to receive signals from the electrical judging apparatus and a control unit configured to allow for the light sources to emit light by processing the signals received by the communication module. In other words, the communication module and the control unit may be connected to the lighting module 130 and the signals transmitted from the electrical judging apparatus may be processed by the communication module and the control unit, thereby allowing for the lighting module 130 to emit light. When a wireless electrical judging apparatus is employed, control may be performed by the wireless electrical judging apparatus.

The operation of the fencing mask 100 equipped with a score light indicator device according to the one embodiment of the present invention will now be described with reference to the accompanying drawings. Each fencer wears the fencing mask 100 equipped with a score light indicator device, and enters a fencing court.

When a competition starts on the fencing court, a fencer performs a competition with his or her opponent by using the fencing weapon 40, and then gains or loses scores. The fencer on the fencing court needs to wear the fencing mask until a referee makes a judgment.

The signals generated during the competition are transmitted to the electrical judging apparatus through the cable 30, and then results are displayed on the scoreboard 20. Simultaneously, the green light source 131, the red light source 133, and the white light source 132 are allowed to emit light. In this case, the light sources emit light individually or in combination.

The green light source 131 and the red light source 133 are located above the eyes of the fencer on a horizontal basis. Furthermore, the light sources are located on the opposite sides of the forehead protector in contact with the forehead of the fencer, and thus light is indirectly radiated onto the eyes of the fencer in an indirect lighting fashion without being indirectly radiated onto the eyes of the fencer, with the result that gains of scores and losses of scores may be easily perceived.

In the case where a gain of a score is set to a green color and a loss of a sore is set to a red color, the green light source 131 emits light in the case of a gain of a score, and the red light source 133 emits light in the case of a loss of a score. In the case of a draw, the white light source 132 emits light. Alternatively, the green light source 131 and the red light source 133 may emit light simultaneously.

Accordingly, the fencing mask equipped with a score light indicator device according to the present invention enables a fencer to immediately become aware of whether or not a score has been gained, and thus the performance of the fencer may be enhanced and the most of the skills of the fencer may be exercised, thereby making the progress of a competition faster and more efficient. Furthermore, effects may be provided in that the base of social sports that enjoy fencing is expended by inducing interest in fencing competition and fencing beginners may easily perceive gains of scores and losses of scores in fencing competition.

In other words, the fencing mask equipped with a score light indicator device according to the present invention has the following effects:

First, the performance of fencers may be enhanced and the most of the skills of the fencers may be exercised.

Second, the progress of a competition may be made faster and more efficient.

Third, an effect is achieved in that the base of social sports that enjoy fencing is expended by inducing interest in fencing competition.

Fourth, fencing beginners may easily perceive gains of scores and losses of scores in fencing competition.

Although the present invention has been specifically described using the embodiments taken with reference to the accompanying drawings, the above-described embodiments are described merely using some examples of the present invention. Accordingly, the present invention should not be interpreted as being limited only to the above-described embodiments, but the scope of the present invention should be interpreted as encompassing the following claims and ranges equivalent to the claims.

What is claimed is:

1. A fencing mask equipped with a score light indicator device, the fencing mask comprising:
a fencing mask body configured to protect a head of a fencer in a fencing competition;
a forehead protector configured to be provided inside the fencing mask body and to protect a forehead of the fencer; and
a lighting module configured to be located between an inside of the mask body and the forehead protector;
wherein the lighting module comprises a plurality of light sources, and the light sources constituting the lighting module selectively emit light in response to electric signals generated by a fencing weapon that is used in fencing.

2. The fencing mask of claim 1, wherein the lighting module comprises a green light source, a red light source, and a white light source.

3. The fencing mask of claim 2, wherein the green light source, the red light source, and the white light source are spaced apart from one another.

4. The fencing mask of claim 3, wherein the green light source, the red light source, and the white light source emit light individually or in combination.

5. The fencing mask of claim 1, wherein the lighting module is controlled by an electrical judging apparatus configured to receive electric signals generated by the fencing weapon and to determine a result of the fencing competition.

6. The fencing mask of claim 5, further comprising a communication module configured to receive signals from the electrical judging apparatus and a control unit configured to process the signals received by the communication module.
